(19) United States
(12) Patent Application Publication
(10) Pub. No.: US 2013/0180996 A1
(43) Pub. Date: Jul. 18, 2013

(54) STRUCTURE FOR INSULATION OF STORAGE TANK AND ITS CONSTRUCTION METHOD

(71) Applicants: Jae Gun Lee, Ulsan (KR); Hyun Jin Yoon, Ulsan (KR); Bong Ju Kim, Ulsan (KR); Woo Jung Park, Seoul (KR); Myung Kuk Joo, Busan (KR)

(72) Inventors: Jae Gun Lee, Ulsan (KR); Hyun Jin Yoon, Ulsan (KR); Bong Ju Kim, Ulsan (KR); Woo Jung Park, Seoul (KR); Myung Kuk Joo, Busan (KR)

(73) Assignee: SK INNOVATION CO., LTD., Seoul (KR)

(21) Appl. No.: 13/823,058

(22) PCT Filed: Sep. 8, 2011
(86) PCT No.: PCT/KR11/06673

§ 371 Date: Mar. 13, 2013

(30) Foreign Application Priority Data
Sep. 15, 2010 (KR) 10-2010-0090706

(51) Int. Cl. B65D 90/06; B23P 11/00

(52) U.S. Cl. CPC B65D 90/06; B23P 11/00
USPC 220/592.24; 29/525.01; 29/525.14

(57) ABSTRACT

An insulation structure for a storage tank and a method of constructing the insulation structure. Angle plates to which expansion joints and wires are assembled are vertically disposed around the storage tank, tensions of the wires, which are horizontally disposed around the storage tank, are adjusted, and then insulation panels having insulating materials attached thereto are disposed to thermally insulate the storage tank in order to protect a kind of oil that is contained in the storage tank.

### TECHNICAL FIELD

The present invention relates to an insulation structure for a storage tank and a method of constructing the insulating structure.

### BACKGROUND ART

In general, a storage tank that stores kinds of oil such as crude oil and bunker-C oil therein is used in the insulated state in order to reduce damage due to the influence of seasons such as the cold season. That is, the storage tank is prevented from being damaged by decreasing changes that occur in the temperature of the kind of oil contained therein by thermally insulating the storage tank from the outside.

Patent Document 1 is representative of such insulation of the storage tank. Patent Document 1 relates to a system for insulating a storage tank that contains fuel, and discloses a system in which an insulating board and an inner layer of a metal sheet are bonded together using a resin in order to insulate the storage tank.

Specifically, in the insulation system disclosed in Patent Document 1, the metal sheet having the inner layer is attached to the outer surface of the storage tank using washers, the insulating board made of Styrofoam, etc. is disposed outside the metal sheet, the metal sheet and the insulating board are bonded together using the resin, and an outer layer formed of woven cloth is disposed outside the insulating board.

Accordingly, Patent Document 1 aims to provide the insulation system, which is disclosed therein, outside the storage tank to isolate and protect fuel, which is contained inside the storage tank, from the outside.

[Prior Art Document]

[Patent Document]

Patent Document 1: US4062468 B1

### DISCLOSURE OF INVENTION

### Technical Problem

However, as described above, Patent Document 1 has a very complicated construction structure in which the inner layer is disposed on the storage tank using the washers, the insulating board is bonded using the resin, and then the outer layer is disposed on the outside of the insulating board.

There is also the problem of unnecessary waste of subsidiary materials and the corresponding increase in cost, since the construction structure of the conventional insulation system is generally made from the upper portion of the storage tank.

In particular, the insulation system disclosed in Patent Document 1 fails to take into consideration that the storage tank repeatedly expands and contracts in the cold and hot seasons. Consequently, the repeated expansion and contraction may cause a structural decrease in the longevity of the insulation system and reducing its lifetime.

Therefore, the present invention is intended to prevent the construction from becoming complex and the corresponding increase in the cost and terms of the work, which are regarded as problems of the insulation structure for a storage tank of the related art including Patent Document 1 above, as well as structural degradation that may result from the expansion and contraction of the storage tank.

One object of the present invention is to provide a structure for the insulation of a storage tank that can simplify the construction of the insulation structure and that respond flexibly to the expansion and contraction of the storage tank.

Another object of the present invention is to provide a method of constructing an insulation structure for a storage tank, in which the insulation structure can be easily constructed.

### Solution to Problem

In an aspect, the present invention provides an insulation structure for a storage tank, including angle plates vertically disposed around the storage tank; expansion joints disposed on the angle plates; wires fastened to the expansion joints and disposed in a lateral direction of the storage tank; and insulation panels fastened to the wires via panel-fastening means. The insulation panels are arranged and disposed outside the storage tank, and have insulating materials attached thereto. The insulating materials are disposed between the storage tank and the insulation panels.

Each of the expansion joints may include a hollow body; a first nut disposed inside the body; a safety bolt fastened to the first nut and exposed to an outside of the body; a disc spring arranged in a front surface of the first nut; an end plate disposed on a front surface of the disc spring; and a hook arranged in front of the end plate and screw-fastened to the safety bolt.

A mark indicating a level may be made on a surface of the safety bolt, the mark enabling a displacement of the disc spring to be measured.

The insulation structure may further include connecting members disposed in the angle plates, wherein a second nut is disposed inside each body of the expansion joints, the second nut enabling each of the expansion joints to be fastened to a corresponding one of the connecting members.

The insulation panels may be bending-processed such that the insulation panels are rendered pliable along a circumference of the storage tank.

The panel-fastening means may include a first clip holder, wherein the first clip holder includes a cylindrical fastener having an open lower portion, which enables the cylindrical fastener to be fitted around a corresponding one of the wires, and a fixing band extending from the cylindrical fastener to fix a corresponding end of the insulation panels.

The panel-fastening means may further include a second clip holder for sealing a corresponding one of the insulating panels.

In another aspect, the present invention provides a method of constructing an insulation structure for a storage tank, including the steps of (A) selecting a storage tank to be insulated; (B) mounting one end of a carriage cable on a ceiling of the storage tank and connecting the other end of the carriage cable to a gondola placed on a ground; (C) assembling an expansion joint to an angle plate and connecting a wire to the expansion joint; (D) disposing the angle plate to which the expansion joint and the wire are assembled around the storage tank using the gondola; and (E) fastening an insulation panel to the wire using the gondola.

Before the carriage cable is connected to the gondola placed on the ground in the step (B), a roller having movable wheels may be placed on a periphery of the ceiling of the storage tank, so that the carriage cable is connected to the gondola via the roller.

In the method of the present invention, in the step (D), upper and lower portions of the angle plate may be welded or bolted to the storage tank.

### Advantageous Effects of Invention

According to the present invention, since the insulation structure is simplified, there are effects in that the storage tank can be easily insulated without the use of unnecessary subsidiary materials, and in that the overall cost of construction is accordingly reduced.

In addition, since the storage tank is insulated by fastening the insulation panels to the wires, which are horizontally disposed around the storage tank, there is the effect of improving the insulation by removing the gaps between the insulation panels and the storage tank.

In particular, the tension of the wires is easily adjusted thanks to the expansion joints, which can respond flexibly to the expansion and contraction of the storage tank. This consequently can prevent a decrease in longevity, such as stretching or breaking, of the wires, thereby increasing the lifetime thereof.

Moreover, according to the construction method of the present invention, there are effects in that the insulation structure can be easily constructed on the storage tank, and in that the overall time required for construction can be accordingly reduced.

### BRIEF DESCRIPTION OF DRAWINGS

FIG. 1 is a perspective view showing an insulation structure provided outside a storage tank according to the present invention;

FIG. 2 is an exploded perspective view showing angle plates, expansion joints and wires, which are assembled together and disposed around the storage tank, according to the present invention;

FIG. 3 and FIG. 4 are cross-sectional views showing the expansion joint and its motion according to the present invention;

FIG. 5 is a perspective view showing the insulation panel fastened to the wire using the first and second clip holders according to the present invention;

FIG. 6 and FIG. 7 are cross-sectional views showing the insulation panel fastened to the wire using the first and second clip holders according to the present invention; and

FIG. 8 and FIG. 9 are cross-sectional views showing a method of constructing the insulation structure according to the present invention.

### DESCRIPTION OF REFERENCE NUMERALS

1: storage tank 10: angle plate

20: expansion joint 30: wire

40: insulation panel 42: insulating material

50: first clip holder 51: second clip holder

### MODE FOR THE INVENTION

Hereinbelow, preferred embodiments of the present invention will be described in detail with reference to the accompanying drawings.

The present invention includes, as basic characteristics in terms of its technical concept, angle plates 10, expansion joints 20, wires, and insulation panels 40. The angle plates 10 are vertically disposed around a storage tank 1, which contains a kind of oil therein, such that they can protect the storage tank 1. The expansion joints 20 are mounted to the angle plates 10, and the wires are fastened to the expansion joints 20 and are horizontally disposed around the storage tank 1. The insulation panels 40 are fastened to the wires 30 via panel-fastening means, enabling the storage tank 1 to be thermally insulated.

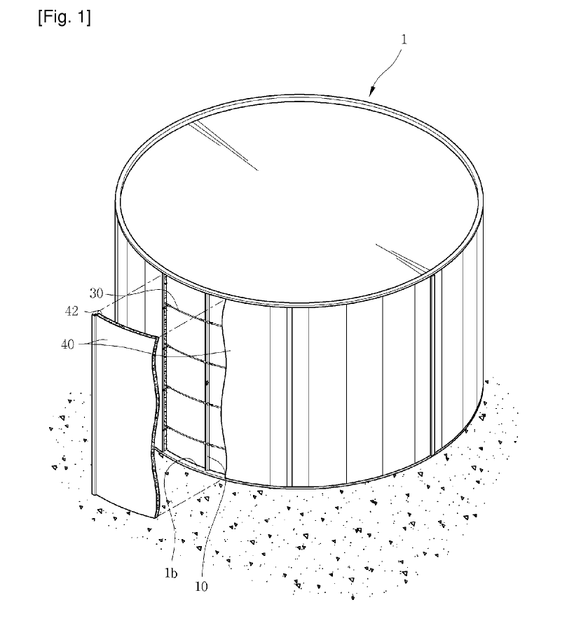

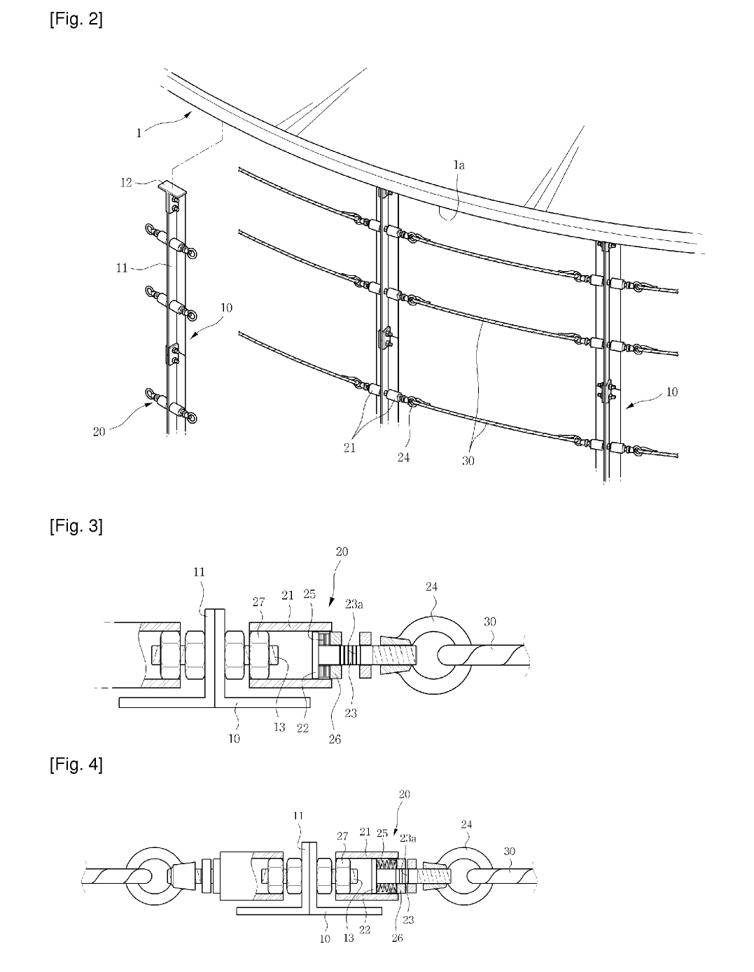

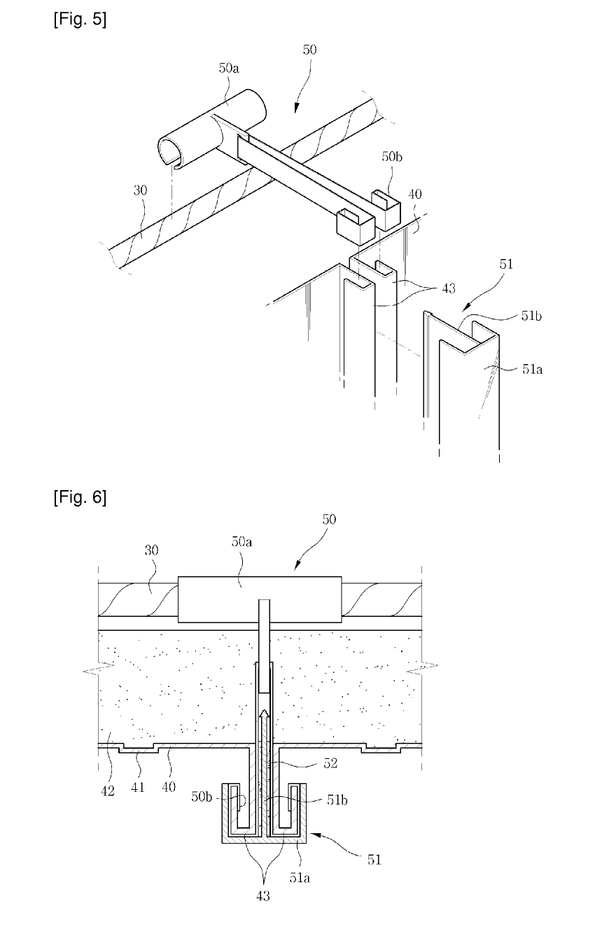

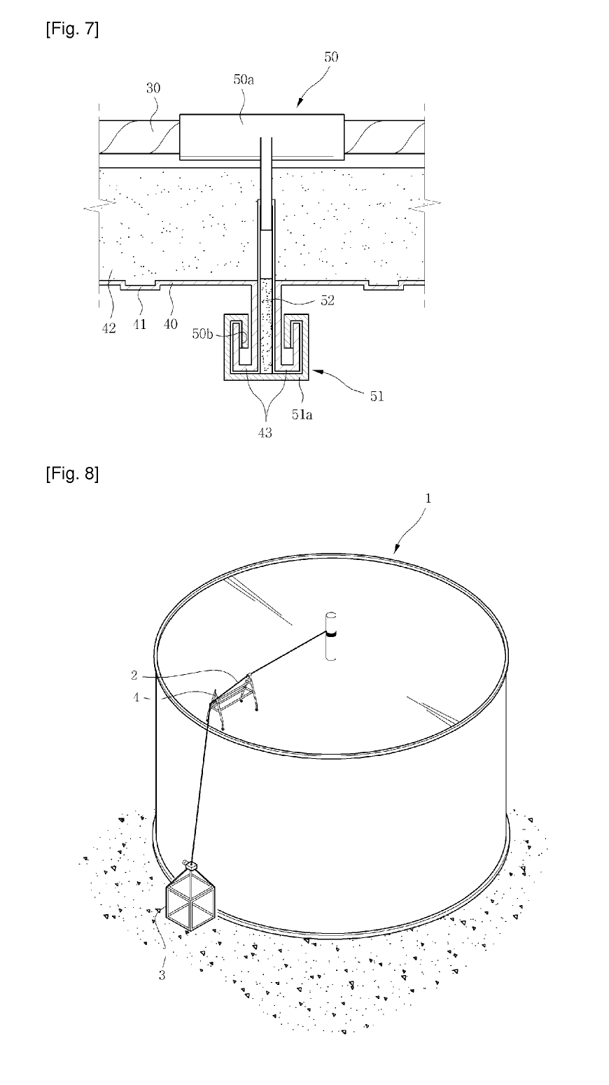

The angle plates 10 are members that allow the expansion joints 20 and the wires 30 to be disposed around the storage tank 1. The angle plates 10 can be used by attaching a pair of well-known angles together such that coupling portions 11 to which the expansion joints 20 are mounted protrude, or by fabricating the angle plates 10 such that they have a similar shape. The overall shape of the angle plates 10 is shown in FIG. 1 and FIG. 2.

The angle plates 10 are vertically disposed around the storage tank 1. Specifically, the angle plates 10 are brought into close contact to the sides of the storage tank 1, and in this state, the upper and lower portions of the angle plates 10 are welded or bolted respectively to upper and lower panels 1a and 1b of the storage tank 1.

Since the upper panel 1a and the lower panel 1b generally protrude out of the storage tank 1, it is possible to connect the upper and lower portions of the angle plates 10 thereto via welding and bolting. For such welding and bolting, additional auxiliary angles 12, as shown in FIG. 2, may be provided respectively on the upper and lower portions of the angle plates 10.

The length of the angle plates 10 may vary depending on the height H of the storage tank 1. Since the angle plates 10 are disposed around the storage tank 1 at predetermined intervals, the number of them may vary depending on the length of the circumference Ø of the storage tank and the interval between them. According to an embodiment of the present invention, the angle plates 10 are installed at 8 places at intervals of 39.25 m in the storage tank 1 that has a size of Ø50,000×20,000 H.

The expansion joints 20 of the present invention are symmetrically disposed on the right and left of the coupling portions 11, which protrude from the angle plates 10. When the angle plates 10 are provided on the storage tank 1, the expansion joints 20 are disposed to intersect the angle plates 10.

As the angle plates 10 are vertically disposed on the storage tank 1, the expansion joints 20 are disposed in the horizontal direction, which intersects the vertical angle plates 10. Consequently, the expansion joints 20 are disposed in this fashion, such that the wires 30 can be horizontally installed around the storage tank 1.

Here, the expansion joints 20 allow the tension of the wires 30 to be adjusted in response to the expansion and contraction of the storage tank 1. For this, the expansion joints 20 are implemented as follows.

Specifically, as shown in FIG. 3 and FIG. 4, a first nut 22 is disposed inside a hollow pipe body, one end of a safety bolt 23 is screwed into the first nut 22, and the other end of the safety bolt 23 is exposed from the body 21 and is then screwed with a hook 24, which is connected with a corresponding wire 30.

In addition, a disc spring 25 is disposed on the front surface of the first nut 22, the displacement of the disc spring 25 being adjusted depending on the expansion and contraction of the wire 30, and an end plate 26 is disposed on the front end of the disc spring 25.

Therefore, when the storage tank 1 expands for example in the hot season, the disc spring 25 is compressed to the maximum amount (deformed 100%) by the first nut 22, as shown in FIG. 3, so that the hook 24 is spaced apart from the body 21. Consequently, the wire 30 connected to the hook 24 corresponds to the expansion of the storage tank 1.

In contrast, when the storage tank 1 contracts for example in the cold season, the disc spring 25 returns to the initial state (deformed 0%) by pushing the first nut 22 due to its own elasticity, as shown in FIG. 4, so that the hook 24 becomes close to the body 21. Such free displacement of the hook 24 allows the wire 30 to constantly be kept under tension and be stretched tight.

The expansion joint 20 is provided with a mark 23a indicating levels such that the displacement of the disc spring 25 can be visually checked by anyone. In the present invention, the mark 23a is made on the surface of the safety bolt 23 such that the displacement can be easily checked.

In the meantime, the number N2 and the interval L4 of the expansion joints 20 provided with respect to the angle plates 10 are calculated as follows:

N2={(circumference of storage tank×rate of expansion)/(n×S1)} or more

L4={(3.14×D)/N2}

Legend

N2: number of expansion joints provided (EA)

L4: interval of expansion joints provided (mm)

D: diameter of storage tank (mm)

n: number of disc springs provided (EA)

S1: rate of deformation of disc spring (mm)

Here, an expansion rate of 0.03% is applied when a kind of oil is contained inside the storage tank.

Consequently, in the present invention, as in the foregoing embodiment, 16 (EA) expansion joints 20 are provided for each of angle plates 10, which are provided at 8 places on the storage tank 1. The expansion joints 20 are provided at intervals of 39.25 M.

Although the expansion joints 20 may be welded to the coupling portions 11 of the angle plates 10, they can be preferably provided using additional connecting members 13 so that they can be easily replaced, for example.

Each of the connecting members 13 has threads on the surface thereof, such that they are fastened first to the angle plates 10 and then screw-fastened to the expansion joints 20. A second nut 27 is provided inside the body 21 of each expansion joint 20 for the screw-fastening of the expansion joint 20 to the connecting member 13.

Consequently, the present invention enables the expansion joints 20 to be mounted on the angle plates 10 via the connecting members 13, thereby reducing the time the work takes and increasing the ease of construction.

The wires 30, which are fastened to the expansion joints 20 and are horizontally disposed around the storage tank 1, are provided with a diameter of 8 mm and a unit weight of 0.237 kg/m according to an embodiment. In another embodiment, wires having a diameter of 9 mm and a unit weight of 0.300 kg/m have been adopted. These embodiments depend on the standards of wire ropes of Korean Standard (KS) No. KSD3514.

The insulation panels 40 of the present invention are mounted outside the storage tank 1 by being fastened to the wires 30. This mounting is repeated such that the insulation panels 40 are arranged along the circumference of the storage tank 1 to thermally insulate the storage tank 1.

Preferably, the insulation panels 40 undergo processing so that they can be bent along the curve of the circumference of the storage tank 1. The insulation panels 40 can be processed into a curved state using protrusions 41, which are bending-processed like this, thereby increasing the ease of construction.

Each of the insulation panels 40 has an insulating material 42, which is disposed between the tank 1 and the panel 40. It is possible to thermally insulate the storage tank 1 using the insulating material 42. In an embodiment, the insulating material 42 is implemented with well-known Rockwool or glass fiber.

Here, the number N1 of the insulation panels 40 provided is calculated as follows:

N1={(3.14×D)/W}×zoning number

Legend

N1: number of insulation panels provided (EA)

W: width of insulation panels (mm)

L1: length of insulation panels (mm)

H: height of storage tank (mm)

D: diameter of storage tank (mm)

Example of Calculation

Size of storage tank: Ø50,000×20,000 H

Length of insulation panel: 5M

Zoning number=20M÷5M=4M

N1={(3.14×50,000)÷928.4}=169.1=170EA

Consequently, insulation panels 40 provided on the storage tank 1 have the dimension of 928.4W×5,000 mm, and are 680 in number: 4(EA)×170(EA)=680(EA).

The panel-fastening means of the present invention includes the first clip holders 50 capable of fastening the insulation panels 40 to the wires 30. In an embodiment, each of the first clip holders 50 includes a fastener 50a, which is fitted around the wire 30, and a fixing band 50b, which extends from the fastener 50a to fix corresponding ends of the insulation panels 40 together. Here, the fastener 50a is cylindrically shaped, and has an open lower portion such that it can be fitted around the wire 30 from above.

It is preferable that ends of the insulation panels 40 are bent following the shape of the fixing band 50b in order to prevent the possibility of separation. For this, in an embodiment, bent fixing portions 43 are formed on ends of insulation panels 40.

The first clip holder 50 can be used by separately fabricating and then assembling the fastener 50a and the fixing band 50b together at a site, or be supplied to the site after having been fabricated as an integral unit in a fabrication plant. Thus, the first clip holder 50 is not specifically limited.

Consequently, such first clip holders 50 enable the insulation panels 40 to be fastened to the wires 30, which are horizontally provided around the storage tank 1, in order to thermally insulate using the insulating materials 42 disposed between the insulation panels 40 and the storage tank 1, thereby safely protecting the kind of oil contained inside the storage tank 1.

The present invention also includes a second clip holder 51 as the panel-fastening means. The second clip holder 51 provides a hermetic seal by sealing gaps that would otherwise form between the insulation panels 40.

That is, as the second clip holders 51 are arranged outside the storage tank 1, each second clip holder 51 includes a fixing cover 51a to press the adjacent fixing portions 43 of the insulation panels 40 from the outside so that the adjacent fixing portions 43 are brought into close contact with each other. A wedge 51b extends from the fixing cover 51a if necessary such that it is fastened to the fixing band 50b.

It is preferable that a well-known adhesive 52 be disposed between the fixing portions 43, which are brought into close contact with each other via the second clip holder 51, in order to increase the effect of a hermetic seal due to sealing.

Consequently, the present invention can block the wind by providing a hermetic seal to the gaps between the insulation panels 40 using the second clip holders 51, thereby further increasing the insulation effect. Consequently, it is possible to safely protect the kind of oil from the influence of seasons such as the cold season.

In addition, the first and second clip holders 50 and 51 enable the structure for insulation of the storage tank of the present invention to meet the requirement cited in the Safety Control of Dangerous Substances Act(“the structure must be disassembled or removed every 10 years to be tested”).

A method of constructing an insulation structure of the present invention is as follows. First, the storage tank 1 to be insulated is selected, and the dimensions of the insulation panels 40 to be used to thermally insulate the storage tank 1 are selected. It is clarified that the formulae for calculating the dimensions of the insulation panel 40 are omitted since it was described above.

Afterwards, as shown in FIG. 8, one end of a carriage cable 2 is mounted on the ceiling of the storage tank, and the other end of the carriage cable 2 is connected to a gondola, which is placed on the ground.

Here, one end of the carriage cable 2 is fixed to a climber support or the like, which is typically installed in the ceiling, and before the other end of the carriage cable 2 is connected to the gondola 3, a roller 4 having movable wheels is placed on the periphery of the ceiling of the storage tank 1.

Therefore, the carriage cable 2, which is placed on the roller 4, is connected to the gondola 3 on the ground. Consequently, it is possible to construct the insulation structure of the present invention while freely moving the gondola 3 along the circumference of the storage tank 1.

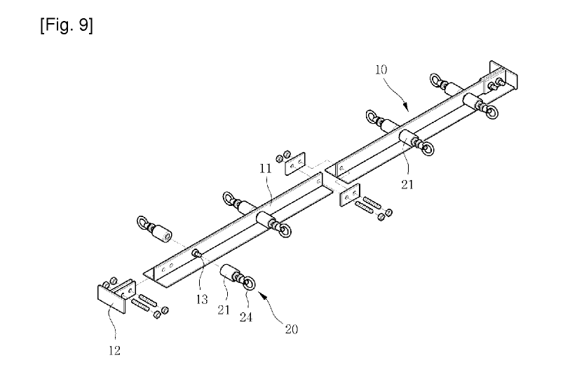

In the meantime, as shown in FIG. 9, the angle plates 10 are placed on the ground. In this state, the expansion joints 20 are mounted on the coupling sections 11 of the angle plates 10, and the wires 30 are connected to the expansion joints 20. The number of the expansion joints 20 at this time is determined by the foregoing calculation formulae. It is preferable in terms of the ease of construction that the wires 30 are provided to the site in the form of having been previously cut and corresponding to the number of the expansion joints 20.

After the expansion joints 20 and the wires 30 are assembled to the angle plates 10, the angle plates 10 are vertically mounted around the storage tank 1 using the gondola 3, which is moved up and down by pulling the carriage cable 2 from the ceiling of the storage tank 1 and to the right and left along the circumference of the storage tank 1 via the roller 4.

The angle plates 10 are mounted by using welding or bolting to connect the upper and lower portions thereof to the upper and lower panels 1a and 1b, respectively. In an embodiment, the angle plates 10 are installed at 8 places at intervals of 39.25 m in the storage tank 1 having the size of Ø50,000×20,000 H.

After the expansion joints 20 and the wires 30 are horizontally mounted on the storage tank 1 by mounting the angle plates 10, the tension of the wires 30 is adjusted using the gondola 3 such that the wires stay tight.

After the tensions of the wires 30 have been completely adjusted, the insulation panels 40 having the insulating materials 42 attached thereto are mounted outside the storage tank 1 by fastening them to the wires 30 using the gondola 3. Here, the panel-fastening means including the first clip holders 50 is used for the fastening.

In addition, the gaps between the insulation panels 40, which are fastened to the wires 30 using the first clip holders 50 and are arranged outside the storage tank 1, are sealing-processed using the second clip holders 51 to have a hermetic seal.

Accordingly, the construction method of the present invention enables the insulation structure to be easily and simply constructed outside the storage tank 1, thereby effectively reducing the time the work takes.

1. An insulation structure for a storage tank, comprising:
angle plates vertically disposed around the storage tank;
expansion joints disposed on the angle plates;
wires fastened to the expansion joints and disposed in a lateral direction of the storage tank; and
insulation panels fastened to the wires via panel-fastening means, wherein the insulation panels are arranged and disposed outside the storage tank, and have insulating materials attached thereto, the insulating materials being disposed between the storage tank and the insulation panels.

2. The insulation structure of claim 1, wherein each of the expansion joints includes:
a hollow body;
a first nut disposed inside the body;
a safety bolt fastened to the first nut and exposed to an outside of the body;
a disc spring arranged in a front surface of the first nut;
an end plate disposed on a front surface of the disc spring; and
a hook arranged in front of the end plate and screw-fastened to the safety bolt.

3. The insulation structure of claim 2, wherein a mark indicating a level is made on a surface of the safety bolt, the mark enabling a displacement of the disc spring to be measured.

4. The insulation structure of claim 1, further comprising connecting members disposed in the angle plates, wherein a second nut is disposed inside each body of the expansion joints, the second nut enabling each of the expansion joints to be fastened to a corresponding one of the connecting members.

5. The insulation structure of claim 2, further comprising connecting members disposed in the angle plates, wherein a second nut is disposed inside each body of the expansion joints, the second nut enabling each of the expansion joints to be fastened to a corresponding one of the connecting members.

6. The insulation structure of claim 3, further comprising connecting members disposed in the angle plates, wherein a second nut is disposed inside each body of the expansion joints, the second nut enabling each of the expansion joints to be fastened to a corresponding one of the connecting members.

7. The insulation structure of claim 1, wherein the insulation panels are bending-processed such that the insulation panels are rendered pliable along a circumference of the storage tank.

8. The insulation structure of claim 1, wherein the panel-fastening means includes a first clip holder, wherein the first clip holder includes a cylindrical fastener having an open lower portion, which enables the cylindrical fastener to be fitted around a corresponding one of the wires, and a fixing band extending from the cylindrical fastener to fix a corresponding end of the insulation panels.

9. The insulation structure of claim 1, wherein the panel-fastening means further includes a second clip holder for sealing a corresponding one of the insulating panels.

10. The insulation structure of claim 8, wherein the panel-fastening means further includes a second clip holder for sealing a corresponding one of the insulating panels.

11. A method of constructing an insulation structure for a storage tank, the method comprising:
(A) selecting a storage tank to be insulated;
(B) mounting one end of a carriage cable on a ceiling of the storage tank and connecting the other end of the carriage cable to a gondola placed on a ground;
(C) assembling an expansion joint to an angle plate and connecting a wire to the expansion joint;
(D) disposing the angle plate to which the expansion joint and the wire are assembled around the storage tank using the gondola; and
(E) fastening an insulation panel to the wire using the gondola.

12. The method of claim 11, wherein, before the carriage cable is connected to the gondola placed on the ground in the step (B), a roller having movable wheels is placed on a periphery of the ceiling of the storage tank, so that the carriage cable is connected to the gondola via the roller.

13. The method of claim 11, wherein, in the step (D), upper and lower portions of the angle plate are welded or bolted to the storage tank.

14. The method of claim 12, wherein, in the step (D), upper and lower portions of the angle plate are welded or bolted to the storage tank.
